(19) United States
(12) Patent Application Publication
(10) Pub. No.: US 2004/0062987 A1
(43) Pub. Date: Apr. 1, 2004

(54) Structure of battery electrolyte container seal

(76) Inventor: Jui-Chih Wang, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/254,597

(22) Filed: Sep. 26, 2002

(51) Int. Cl. H01M 2/08; H01M 2/04; H01M 2/36

(52) U.S. Cl. 429/185; 429/175; 429/80

(57) ABSTRACT

A structure of battery electrolyte container seal comprises a container, a plurality of resilient caps and a plurality of hard plugs; the cap being provided in an opening of the container; the plug in shape of a bead being inserted into a through hole of the cap; a body of the cap being fixed onto inner wall of and fully sealing up the opening of the container to reduce resistance encountered upon opening up the container for easy and rapid opening while assuring of integral sealing of the container.

### BACKGROUND OF THE INVENTION

(a) Field of the Invention

The present invention relates to a structure of battery electrolyte container seal, and more particularly to one composed of a resilient cap and a hard plug to provide complete sealing for the container.

(b) Description of the Prior Art

Batteries generally available in the market today are usually shipped with the electrolyte separately packaged and the electrolyte is only filled into the battery upon completing the installation of the battery for use so to prevent loss of potentials due to premature fill of the electrolyte before the use of the battery. Structures of prior electrolyte containers can be roughly classified into the following types:

1. As illustrated in FIG. 4 of the accompanying drawings, an electrolyte container (A) is composed of a plurality of bottles (A1) connected in a row. An opening (A2) of each bottle (A1) is sealed up with a plastic cap (A3) to prevent leakage of the electrolyte. The plastic cap (A3) has its bottom (A4) separately provided with a film C-ring (A5). The opening (A2) is sealed by high frequency (HF) welding the plastic cap (A3) to the opening (A2). In use, a funnel (B) as illustrated in FIG. 5 designed in a hood shape by compromising the appearance of the electrolyte container (A). The funnel (B) is segregated into multiple units with each unit containing a hollow sting (B1). The funnel (B) is placed upon to cover the electrolyte container (A) for each sting (B1) to be aligned to its corresponding opening (A2). Force is applied onto the funnel (B) for the sting (B1) to pierce through the plastic cap (A3) in the opening (A2) (i.e., the film C-ring (A5) is torn apart). The electrolyte container (A) together with the funnel (B) is then aligned to electrolyte inlet of the battery to fill the electrolyte into the battery as guided by the funnel (B).

2. FIG. 6 shows another type of conventional seal structure of an electrolyte container (A). Similarly, its is also composed of a plurality of bottles (A1) connected in a row. An opening (A2) of each bottle (A1) is covered up with an aluminum foil (A6); the sting (B) from the funnel (B) is used to pierce through the aluminum foil (A6). The electrolyte container (A), together with the funnel (B) is aligned to the electrolyte inlet of the battery for the electrolyte in the bottle (A1) to flow into the battery as guided by the funnel (B).

3. Another seal type yet of the prior art as illustrated in FIG. 7 is popularly used in the trade. Wherein, each opening (A2) of the electrolyte container (A) is threaded, and a threaded cap (A7) is engaged to the opening (A2) to seal the opening of the container (A1).

However, in any of the sealing methods as described above for the electrolyte container (A), there are deficiencies as follows pending solutions:

1. The plastic cap (A3) is too hard to permit an easy pierce by the sting (B1) also made of plastic material; and it is difficult to maintain the balance of the electrolyte container (A), resulting in possible seepage of the electrolyte.

2. Though the aluminum foil cap (A6) is easier to be pierced through when compared to the plastic cap (A3), it is vulnerable to be pierced through by accident, again, resulting in possible seepage of the electrolyte.

3. Certain portion of the plastic cap (A3) or the aluminum foil cap (A6) when pierced through with the sting (B1) will always remain being attached to the opening (A2) of the electrolyte container (A) that prevents a smooth delivery of electrolyte into the battery.

4. The sealing process gets comparatively sophisticate either in the case of the plastic cap (A3) or the aluminum foil cap (A6) is used to seal the opening (A2) of the electrolyte container (A). Furthermore, sealing machinery must be made available for the sealing, leading to higher production cost.

5. During the filling process of the electrolyte into the battery, the pierced aluminum foil cap (A6) will react with the metallic nature of the aluminum foil to cause the deterioration of the electrolyte, and the deteriorated electrolyte will affect the quality of the battery.

6. The threaded cap (A7) though having been tightened up to seal the opening (A2) of the electrolyte container (A), it can be easily loosened up during the shipment for the electrolyte to flow out to erode other objects; and the remaining electrolyte can become insufficient for the battery to affect the quality of the battery. Furthermore, it consumes too much time for the fill of the electrolyte into the battery since all the caps (A7) have to be loosened and removed one by one; and that is particularly inconvenient for a task that requires mass fill of electrolyte.

To overcome those defectives as described above, this inventor has developed an improved structure for the electrolyte container (A) and is patented by many countries. As illustrated in FIG. 8, the electrolyte container (A) is also composed of plurality of bottles (A1) connected in a row. A cylindrical plug (A8) made of foam material is inserted into the opening (A2) of each bottle (A1) to seal up the opening (A2) by taking advantage of the resilience of the plug (A8) to prevent the electrolyte contained in the bottle (A1) from flowing out. A funnel of the prior art is also used to cover up on the electrolyte container (A) for each sting (B1) inside the funnel (B) to be aligned to the corresponding opening (A2) of each bottle (A1). Force is applied to press the funnel (B) for the sting (B1) to push the plug (A8) down into bottle (A1) and to float on the level. The floating plug (A8) will not block up the opening (A2) and the electrolyte in the container (A) is able to be filled through the opening (A2) as guided by the funnel (B) into the battery. However, the plug (A8) will be deformed due to expansion to cause small amount of leakage of the electrolyte. Meanwhile, it is found that upon piercing through the plug (A8) with the sting, an extremely great resistance is encountered since the plug is made of foam material, causing problems in the application.

### SUMMARY OF THE INVENTION

The primary purpose of the present invention is to provide an improved structure of battery electrolyte container seal that ensures complete sealing of the container, allows easy and rapid opening, and helps identification of the level of electrolyte in the container.

### BRIEF DESCRIPTION OF THE DRAWINGS

FIG. 1 is an exploded view of a preferred embodiment of the present invention.

FIG. 2 is a cross-sectional view of the preferred embodiment of the present invention as assembled.

FIG. 3 is a view of the preferred embodiment of the present invention in use.

FIG. 4 is a view of a first prior battery container.

FIG. 5 is a view showing a funnel of a prior art.

FIG. 5A is a partially enlarged view of FIG. 5.

FIG. 6 is a view of a second prior battery container.

FIG. 7 is a view of a third prior battery container.

FIG. 8 is a view of a fourth battery container.

### DETAILED DESCRIPTION OF THE PREFERRED EMBODIMENTS

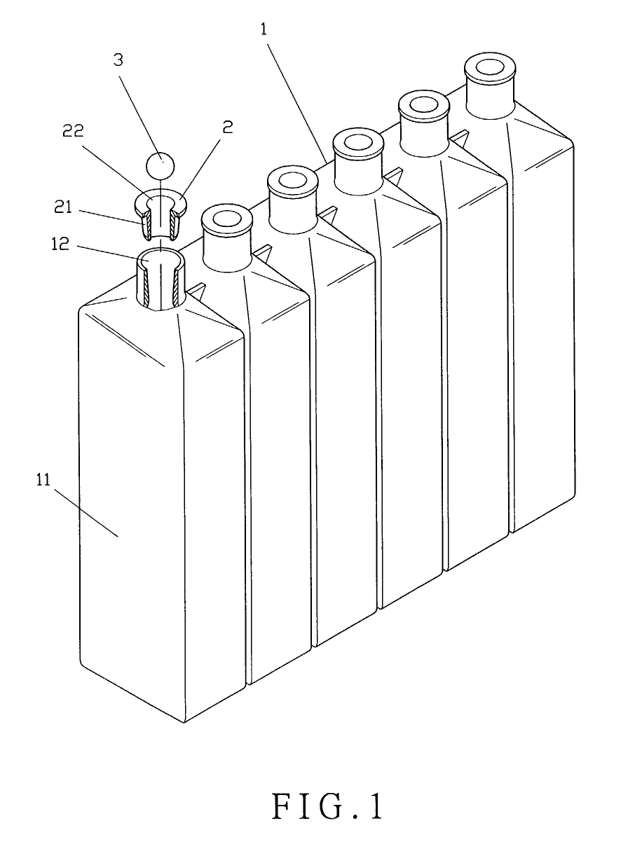

Referring to FIG. 1, a structure for electrolyte container seal of the present invention includes an electrolyte container (1), a plurality of caps (2) and a plurality of plugs (3).

The electrolyte container (1) is composed of a plurality of bottles (11) connected in a row. An opening (12) is provided at the top of each bottle (11). The inner diameter of the opening (12) is reducing and indicates an inverse conic shape.

Each of the caps (2) made of resilient material is placed in the opening (12) of the electrolyte container (1). A body (21) provided to the cap (2) is also an inverse conic shape and contains a through hole (22).

Each of the plugs (3) inserted into the through hole (22) of the cap (2) is made of hard material with a specific gravity not greater than 1.22 to give it the floating capacity in the bottle (11) containing electrolyte as required. The plug (3) is made in a bead shape, applied with a coating of bright color and emitting fluorescence.

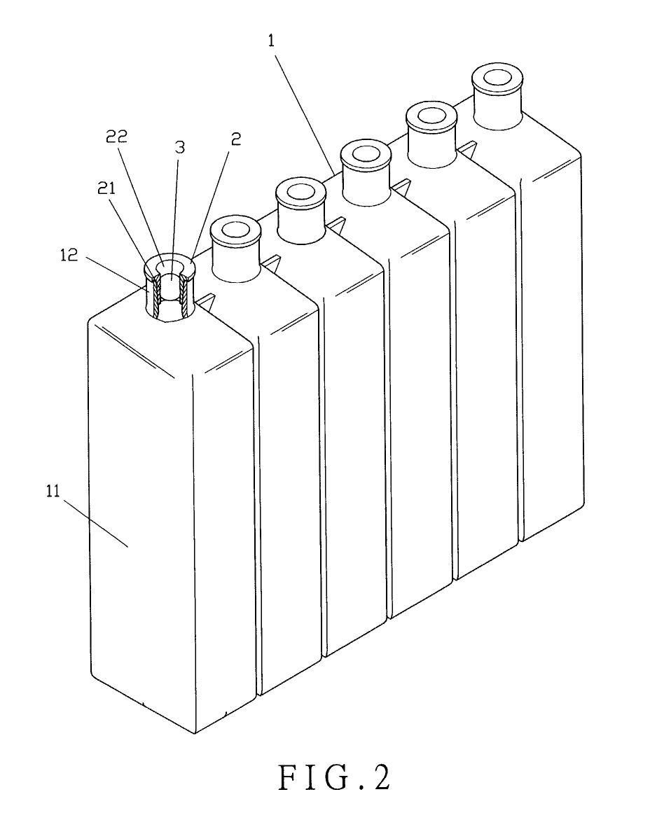

When assembled as illustrated in FIG. 2, the plug (3) is inserted into the through hole (22) of the cap (2). The body (21) of the cap (2) is then placed into the opening (12) of the electrolyte container (1). As both of the body (21) of the cap (2) and the opening (12) are made in the same inverse conic shape, the body (21) of the cap (2) and the opening (12) are able to completely bind to each other. Furthermore, as the plug (3) is made of hard material and the cap (2) is made of resilient material, the plug (3) when inserted into the through hole (22) of the cap (2), holds against the through hole (22), and thus to cause the body (21) of the cap (2) to expand and to hold fast to the inner wall of the opening (2). Consequently, the body (21) of the cap (2) completely seals up the opening (12), thus the electrolyte container (1) without any possible leakage of the electrolyte.

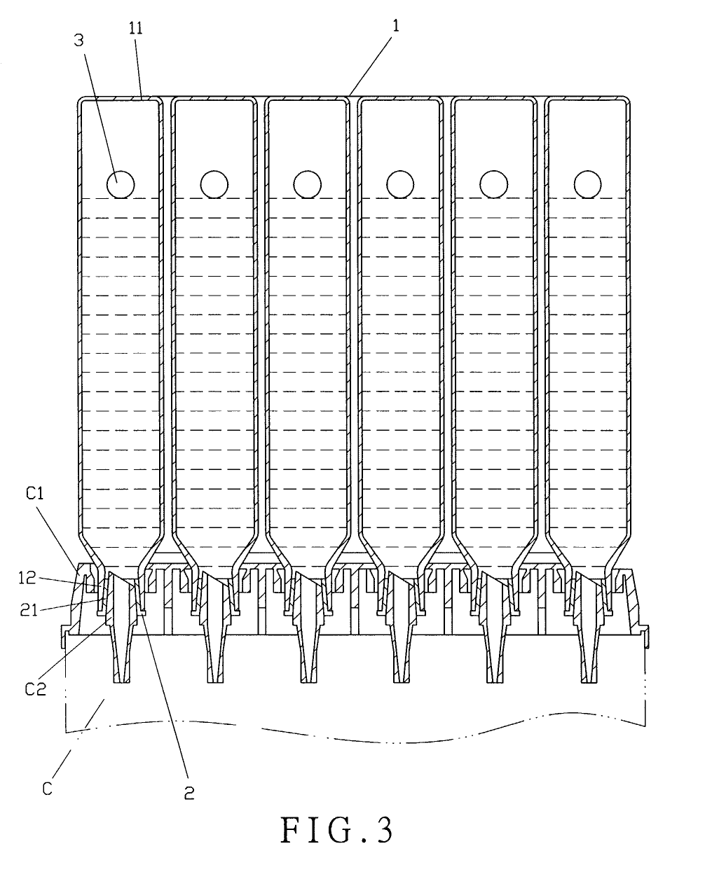

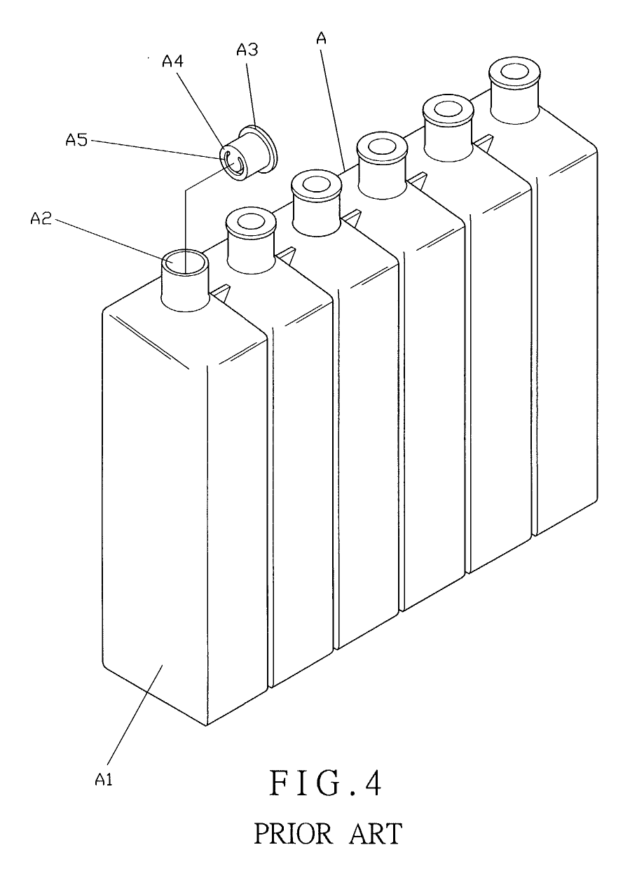

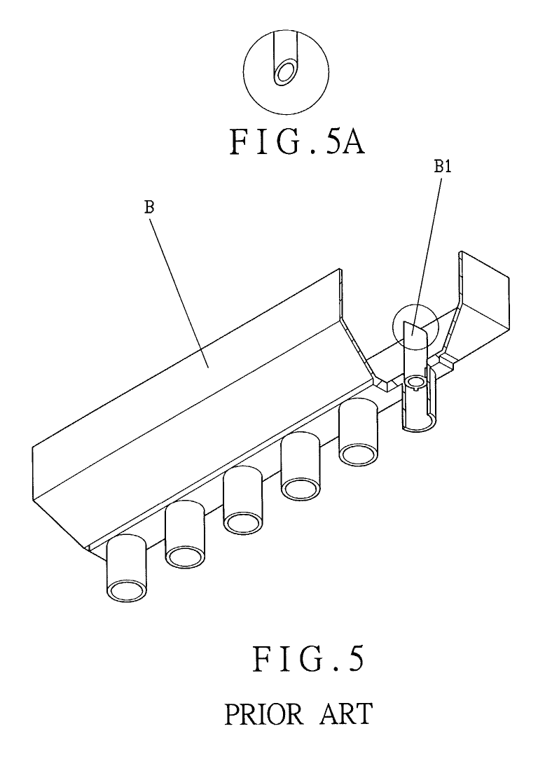

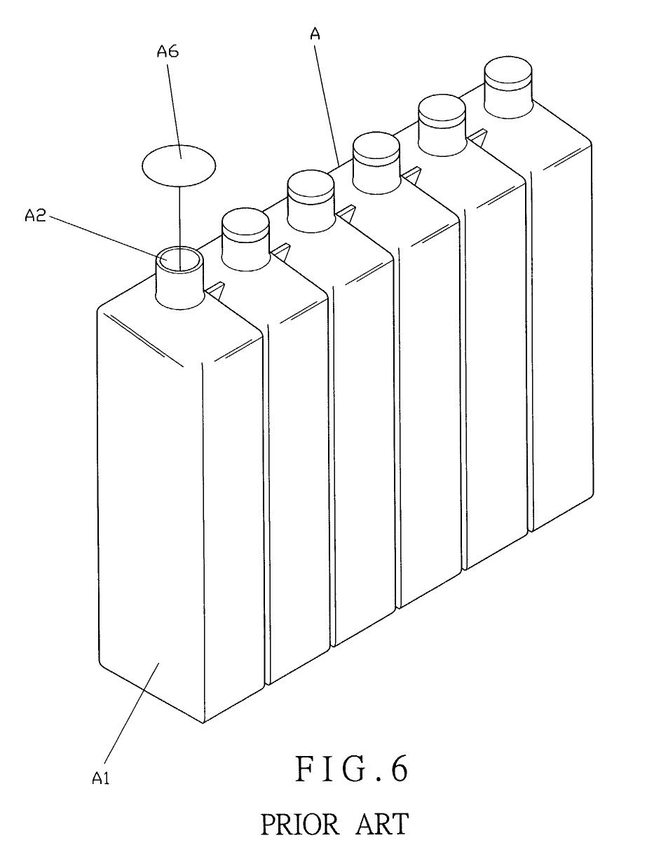

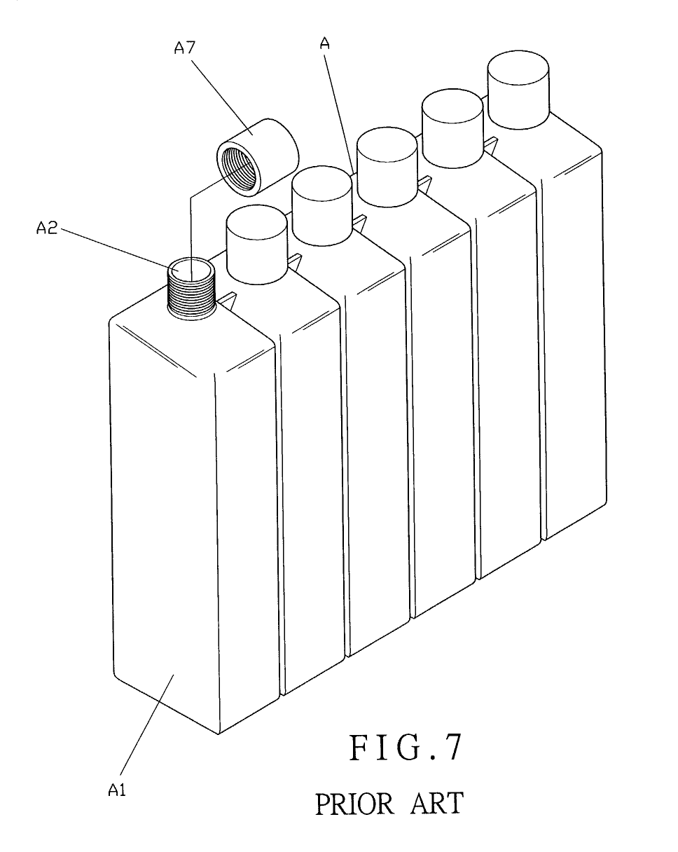

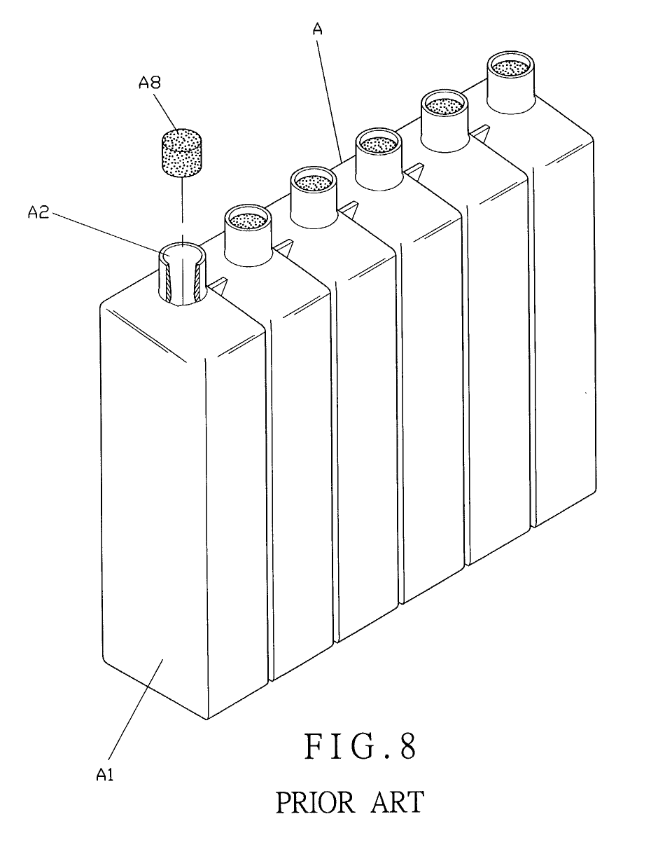

When the electrolyte is to be poured out, the electrolyte container (1) must be opened up. As illustrated in FIG. 3, the electrolyte container (1) is placed up side down for each opening (12) of the bottle (11) to be aligned to a corresponding inlet (C1) of a battery (C). A lever (C2) is provided inside each inlet (C1). When force is applied to press down the electrolyte container (1), the lever (C2) pushes against the plug (3) in the cap (2) at the opening (12), and the plug (3) as being made in a bead shape, can be easily pushed away to clear from the through hole (22) of the cap (2). As the specific gravity of the plug (3) is not greater than 1.2, the plug (3) will float on the level of the electrolyte without blocking up the opening (21), so to permit smooth flow of the electrolyte in the electrolyte container (1) into the battery (C) through the inlet (C1). Furthermore, the plug (3) is made in bright color and fluorescent to help identify the level of the electrolyte in the container (1) during daytime or night hours to ensure of a rapid and convenient filling of electrolyte into the battery.

As disclosed above, the present invention provides the following advantages:

1. By having the plug made of hard material to be inserted into the cap made of resilient material, the body of the cap is capable of holding fast to the inner wall of the opening of the bottle and completely sealing up the opening to warrant no leakage of the electrolyte in the bottle.

2. As the plug is made in a bead shape, it creates comparatively smaller resistance upon opening up the electrolyte container to facilitate the filling of electrolyte into the battery.

3. The plug will completely fall into the bottle when the bottle is opened up and floats on the electrolyte without blocking up the opening of the bottle to frustrate the smooth flow of the electrolyte into the battery.

4. No other sealing machine is required to insert the plug into the cap, or to insert the cap into the opening to offer fast and easy insertion and save production cost.

5. As the plug is made in bright color and fluorescent, it helps an immediate judgment of the level of electrolyte in the bottle either during daytime or night hours.

I claim:

1. A structure of battery electrolyte container seal comprising a battery electrolyte container, a plurality of caps and a plurality of plugs, wherein,
said battery electrolyte container including a plurality of bottles connected in a row with each of said bottles provided an opening at the top, characterized by that:
each of said caps, made of resilient material, being inserted into said opening of said battery electrolyte container; a body being provided to said cap and a through hole being provided inside said body; and each of said plugs, made of hard material, being inserted into said through hole of said cap.

2. The structure of battery electrolyte container seal as claimed in claim 1, wherein, an inner diameter of said opening of said battery electrolyte container is reducing to indicate an inverse conic shape.

3. The structure of battery electrolyte container seal as claimed in claim 1, wherein, said body of said cap is an inverse conic shape.

4. The structure of battery electrolyte container seal as claimed in claim 1, wherein, said plug has a specific gravity not greater than 1.22 to permit said plug floating above electrolyte in said battery electrolyte container.

5. The structure of battery electrolyte container seal as claimed in claim 1, wherein, said plug is a bead.

6. The structure of battery electrolyte container seal as claimed in claim 1, wherein, said plug is applied with a bright color and emits fluorescence for identification.
